(19) United States
(12) Patent Application Publication
(10) Pub. No.: US 2021/0101474 A1
(43) Pub. Date: Apr. 8, 2021

(54) TANK HOLDING DEVICE AND A VEHICLE HAVING THE SAME

(71) Applicants: KWANG YANG MOTOR CO., LTD., Kaohsiung (TW); KAWASAKI JUKOGYO KABUSHIKI KAISHA, Kobe-Shi (JP)

(72) Inventors: Chuang-Hsiung LIN, Kaohsiung City (TW); Teruaki YAMAMOTO, Kobe-Shi (JP)

(21) Appl. No.: 17/127,054

(22) Filed: Dec. 18, 2020

Related U.S. Application Data
(62) Division of application No. 15/923,600, filed on Mar. 16, 2018.

(51) Int. Cl. B60K 15/067; B60K 15/063; B60K 15/03

(52) U.S. Cl. CPC B60K 15/067; B60K 15/063; B60K 2015/03453; B60K 2015/03375; B60K 15/03

(57) ABSTRACT

A tank holding device is adapted to be mounted to a vehicle. The vehicle includes a mounting frame, a holding frame that is disposed on the mounting frame, and a tank that is disposed between the mounting frame and the holding frame. The tank holding device includes a positioning unit that is adapted to be connected to the holding frame and adapted for pushing the tank tightly against the mounting frame so as to secure the tank on the mounting frame.

### CROSS REFERENCE TO RELATED APPLICATIONS

This application is a Divisional Application of co-pending application Ser. No. 15/923,600, filed on Mar. 16, 2018, for which priority is claimed under 35 U.S.C. § 120, the entire contents of all of which are hereby incorporated by reference.

### FIELD

The disclosure relates to a holding device, and more particularly to a tank holding device in a vehicle.

### BACKGROUND

A utility vehicle is a slow, but multipurpose vehicle that is commonly driven to transport passengers or goods in a simple environment, such as a golf course or a factory. Most of the utility vehicles utilize traditional gasoline-powered system, where the gasoline is transferred from an external tank.

Referring to FIG. 1, a vehicle frame 1 of a conventional utility vehicle includes a mounting frame 11, a holding frame 12 that is attached to the mounting frame 11, a tank 13 that is disposed between the mounting frame 11 and the holding frame 12, and a pair of screws 14 that secure the tank 13 directly onto the mounting frame 11 through their respective through holes. While the mounting frame 11 and the holding frame 12 confine the tank 13 therebetween, the holding frame 12 serves no role in holding the tank 13 in place. In other words, without a buffer system, stress exerted by the tank 13 due to external lateral movement (e.g. sudden bump in driving) is all concentrated toward the screws 14, which can easily damage the screws 14 and the through holes, or even damage the tank 13. In addition, the tank 13 may be made with different configurations, which may come with misaligned through holes incapable to fit the screws 14 therethrough for securing the tank 13 onto the mounting frame 11.

### SUMMARY

Therefore, an object of the disclosure is to provide a tank holding device that can alleviate at least one of the drawbacks of the prior art.

Another object of the disclosure is to provide a vehicle having the tank holding device.

According to one aspect of the disclosure, a tank holding device is adapted to be mounted to a vehicle. The vehicle includes amounting frame, a holding frame that is disposed on the mounting frame, and a tank that is disposed between the mounting frame and the holding frame. The tank holding device includes a positioning unit that is adapted to be connected to the holding frame and adapted for pushing the tank tightly against the mounting frame so as to secure the tank on the mounting frame.

According to another aspect of the disclosure, a vehicle includes a vehicle frame, a tank, and a tank holding device. The vehicle frame includes amounting frame and a holding frame that is disposed on the mounting frame. The tank is disposed between the mounting frame and the holding frame. The tank holding device includes a positioning unit that is connected to the holding frame and that is disposed for pushing the tank tightly against the mounting frame so as to secure the tank on the mounting frame.

### BRIEF DESCRIPTION OF THE DRAWINGS

Other features and advantages of the disclosure will become apparent in the following detailed description of the embodiments with reference to the accompanying drawings, of which:

FIG. 1 is a fragmentary perspective view of a conventional tank holding device in a vehicle frame;

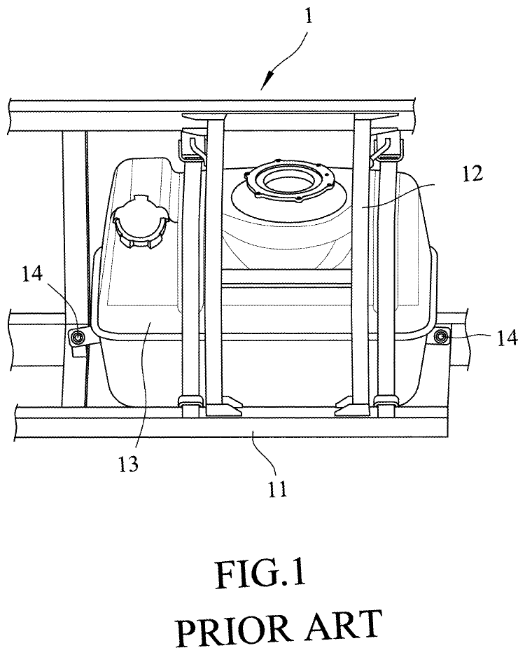

FIG. 2 is a top view of an embodiment of a vehicle according to the disclosure;

FIG. 3 is a partly fragmentary, exploded perspective view of a tank holding device of the embodiment;

FIG. 4 is a partly fragmentary, assembled perspective view of the embodiment;

FIG. 5 is a fragmentary sectional view of the embodiment; and

FIG. 6 is a partly exploded sectional view of a cushion member, a coupling member, a nut and a threaded member of the embodiment.

### DETAILED DESCRIPTION

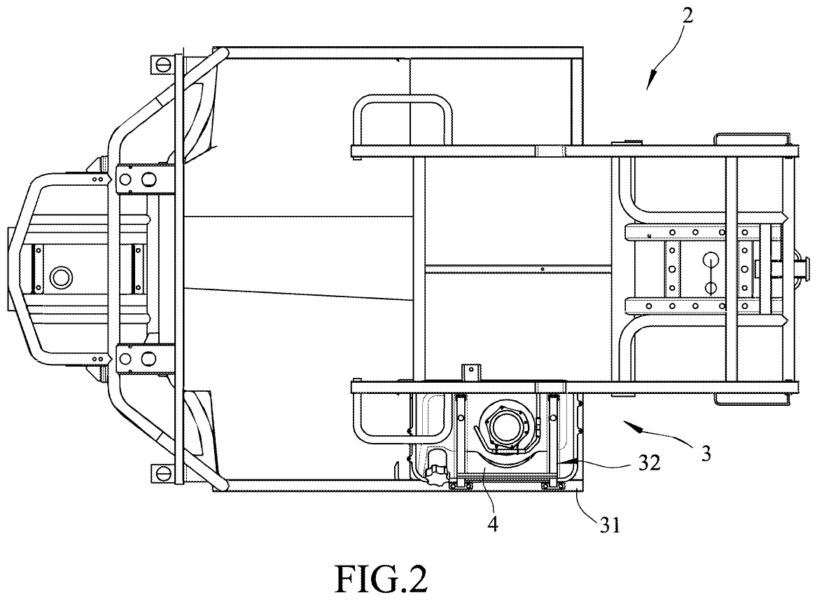

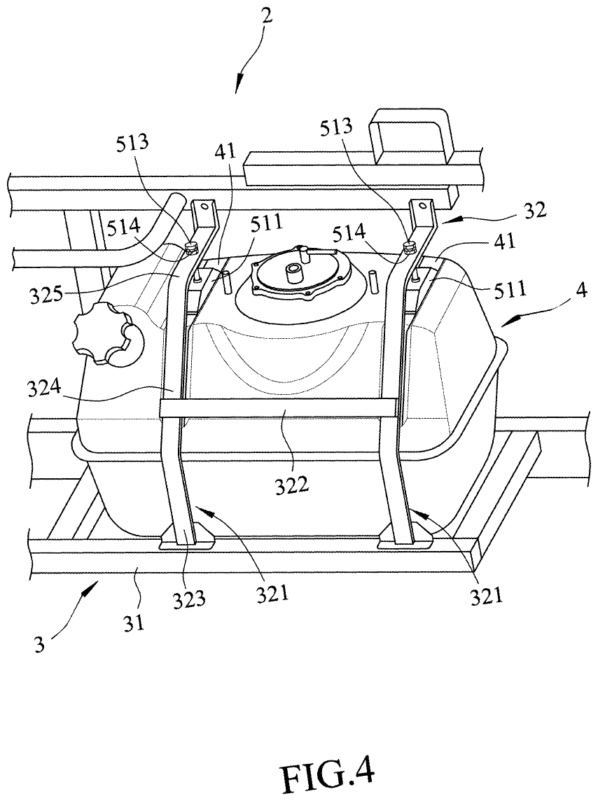

Referring to FIGS. 2 to 4, an embodiment of the vehicle 2 according to the disclosure includes a vehicle frame 3, a tank 4 disposed on the vehicle frame 3, and a tank holding device 5 disposed on the vehicle frame 3 for securing the tank 4 thereon. In this embodiment, the tank 4 is disposed on either left or right side of the vehicle frame 3, but it may be disposed elsewhere in other embodiments.

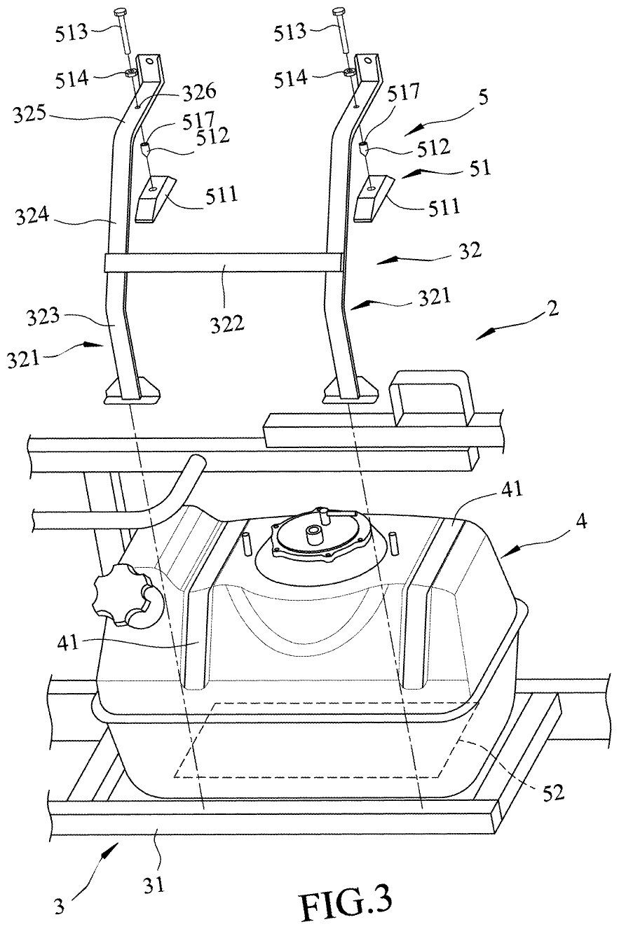

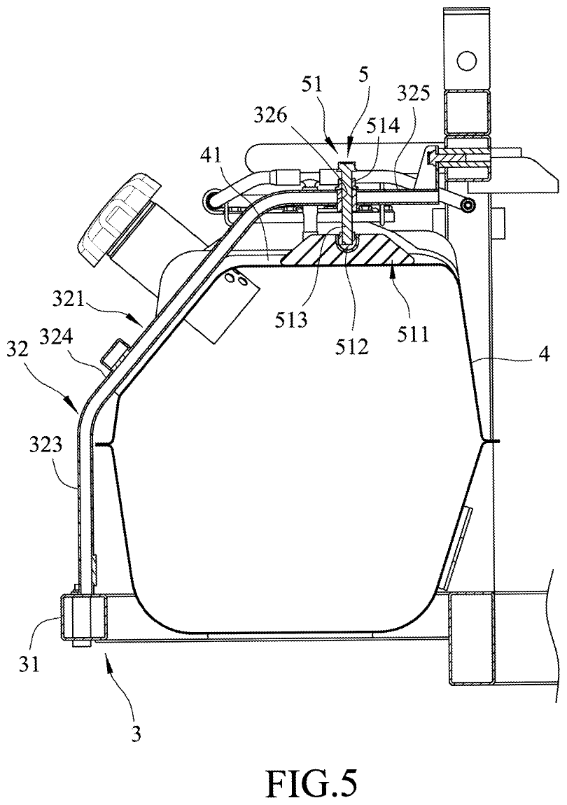

Referring to FIGS. 3 to 5, the vehicle frame 3 includes a mounting frame 31 and a holding frame 32 disposed on the mounting frame 31. The holding frame 32 has a plurality of spaced-apart support segments 321 connected fixedly to the mounting frame 31, and a connecting segment 322 interconnecting the support segments 321. Each of the support segments 321 has a lower support part 323 that is secured to a lower portion of the mounting frame 31, an inclined part 324 that extends obliquely from the lower support part 323 and that is connected to the connecting segment 322, and an upper support part 325 that extends substantially horizontally from the inclined part 324, and that is secured to an upper portion of the mounting frame 31. The upper support part 325 of each of the support segments 321 is formed with a threaded hole 326. In this embodiment, the threaded hole 326 extends substantially vertically in the upper support part 325, but it may extend diagonally in other embodiments. The tank 4 is disposed between the mounting frame 31 and the holding frame 32, and is formed with a plurality of horizontally spaced-apart retaining grooves 41 retaining respectively the inclined parts 324 of the support segments 321. While the above configuration allows the support segments 321 to confine the tank 4 from horizontal movement, the upper support parts 325 of the support segments 321 are actually disposed above the tank 4 and does not fit into the retaining groove 41 directly.

The tank holding device 5 includes a positioning unit 51 that is connected to the holding frame 32 of the vehicle frame 3, and a shock absorbing unit 52 disposed between the mounting frame 31 and the tank 4. The shock absorbing unit 52 is made of soft material, such as rubber or foam, for absorbing shock impulses from the vehicle frame 3 to the tank 4. In the embodiment, the positioning unit 51 is adapted to extent threadedly through the holding frame 32, and has two cushion members 511, two coupling members 512, two threaded members 513 and two nuts 514. Each of the cushion members 511 is disposed between the tank 4 and the upper support part 325 of a respective one of the support segments 321 of the holding frame 32, and is retained by a respective one of the retaining grooves 41. The coupling members 512 abut respectively against the cushion members 511 and are disposed between the cushion members 511 and the holding frame 32. Each of the threaded members 513 extends threadedly through the threaded hole 326 of the upper support part 325 of a respective one of the support segments 321 to be connected to the holding frame 32. The nuts 514 are disposed on the holding frame 32, and are connected threadedly and respectively to the threaded members 513.

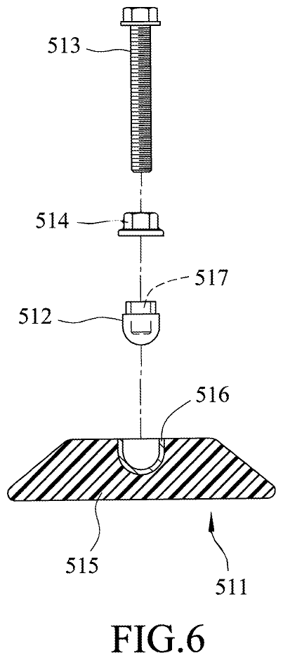

The configuration of each of the cushion members 511 being retained by a respective one of the retaining grooves 41 prevents the respective cushion members 511 from sliding. As shown in FIG. 6, each of the cushion members 511 has a main portion 515 that is made of rubber, and an abutment portion 516 that is embedded in a top end of the main portion 515 and that defines a receiving space receiving a respective one of the coupling members 512. The abutment portion 516 is made from a hard material such as iron and is made with the main portion 515 as one piece. Each of the coupling members 512 is disposed between a respective one of the cushion members 511 and the upper support part 325 of a respective one of the support segments 321, and has an end formed with a threaded engaging hole 517 (see FIG. 3) that is engaged threadedly with a respective one of the threaded members 513, and an opposite end abutting against the abutment portion 516 of a respective one of the cushion members 511. The abutment portions 516 disperse external force from the coupling members 512 equally throughout the main portions 515 to extend the service life of the main portions 515. Each of the threaded members 513 has two opposite ends, each of which is on opposite sides of the upper support part 325 of a respective one of the support segments 321. The lower end of each of the threaded members 513 engages threadedly with the threaded engaging hole 517 of a respective one of the coupling members 512. Each of the nuts 514 is disposed on the top side of the upper support part 325 of a respective one of the support segments 321, and each of the coupling members 512 is disposed on the bottom side of the upper support part 325 of a respective one of the support segments 321.

When either of the threaded members 513 is adjusted, it is threadedly moved upward or downward to pull or push a respective one of the coupling members 512, which in terms releases or exerts force toward a respective one of the cushion members 511 against the tank 4. As such, the threaded member 513 is adapted for pushing a respective one of the cushion members 511 tightly against the tank 4 to secure the tank 4 from any movement. After the adjustment, each of the threaded members 513 may be further secured by threadedly engaging the respective nuts 514 thereto against the respective upper support parts 325. Due to bigger contact area between the cushion members 511 and the tank 4, exerted force between the two elements is better dispersed throughout to prevent damage to the structure of the tank 4 or the tank holding device 5. The abovementioned adjusting configuration of the threaded members 513 may accommodate uses of tanks of different dimensions to improve the compatibility of the tank holding device 5. For each of the positioning units 51, outer surface area of the coupling member 512 is greater than surface area of the threaded member 513 in direct contact with the coupling member 512, such that axial force exerted from the threaded member 513 to the cushion member 511 may be equally dispersed over a larger surface area, creating an overall smaller pressure suitable for extending service life of the cushion member 511.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been de scribed in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A vehicle comprising:
a vehicle frame including a mounting frame, and a holding frame that is disposed on said mounting frame;
a tank disposed between said mounting frame and said holding frame; and
a tank holding device including a positioning unit that is connected to said holding frame and that is disposed for pushing said tank tightly against said mounting frame so as to secure said tank on said mounting frame.

2. The vehicle as claimed in claim 1, wherein said positioning unit of said tank holding device includes:
a plurality of cushion members disposed between said holding frame and said tank; and
a plurality of threaded members connected to said holding frame, each of said threaded members being connected threadedly to one of said holding frame and said cushion member, and disposed for pushing a respective one of said cushion members tightly against said tank.

3. The vehicle as claimed in claim 2, wherein said tank is formed with a plurality of retaining grooves retaining respectively said cushion members.

4. The vehicle as claimed in claim 3, wherein said holding frame has:
a plurality of spaced-apart support segments connected fixedly to said mounting frame, each of said support segments having
a lower support part that is secured to a lower portion of said mounting frame,
an inclined part that extends obliquely from said lower support part and that is retained in the respective one of said retaining grooves, and
an upper support part that extends substantially horizontally from said inclined part, and that is secured to an upper portion of said mounting frame; and
a connecting segment interconnecting said support segments.

5. The vehicle as claimed in claim 4, wherein:
each of said support segments of said holding frame is formed with a threaded hole; and
each of said threaded members of said positioning unit extends threadedly through said threaded hole of a respective one of said support segments.

6. The vehicle as claimed in claim 2, wherein said positioning unit further includes a plurality of nuts disposed on said holding frame, and connected threadedly and respectively to said threaded members.

7. The vehicle as claimed in claim 6, wherein said positioning unit further includes a plurality of coupling members connected respectively to said threaded members and abutting respectively against said cushion members, each of said coupling members being disposed between a respective one of said support segments and a respective one of said cushion members.

8. The vehicle as claimed in claim 7, wherein each of said coupling members has an end formed with a threaded engaging hole that is engaged threadedly with a respective one of said threaded members, and an opposite end abutting against a respective one of said cushion members.

9. The vehicle as claimed in claim 8, wherein each of said cushion members has:
a main portion that is made of rubber; and
an abutment portion that is made of iron, that is embedded in a top end of said main portion, and that defines a receiving space receiving a respective one of said coupling members.

10. The vehicle as claimed in claim 1, wherein said tank holding device further includes a shock absorbing unit disposed between said mounting frame and said tank.
